(19) United States
(12) Patent Application Publication
(10) Pub. No.: US 2020/0238875 A1
(43) Pub. Date: Jul. 30, 2020

(54) MOTOR VEHICLE SEAT SYSTEM AND METHOD FOR OPERATING SAME

(71) Applicant: Faurecia Autositze GmbH, Stadthagen (DE)

(72) Inventors: Tomasz Godlewski, Swidnica (PL); Lukasz Kunicki, Walbrzych (PL); Jaroslaw Mikulski, Wroclaw (PL)

(73) Assignee: Faurecia Autositze GmbH, Stadthagen (DE)

(21) Appl. No.: 16/696,273

(22) Filed: Nov. 26, 2019

(30) Foreign Application Priority Data
Jan. 25, 2019 (DE) 102019101935.4

(51) Int. Cl. B60N 2/90; B60N 2/66; B60N 2/72

(52) U.S. Cl. CPC B60N 2/976; B60N 2/914; B60N 2002/981; B60N 2/72; B60N 2/99; B60N 2/665

(57) ABSTRACT

A motor vehicle seat having bubbles that can be filled with fluid, a controller, and a line system connected to the bubbles. The bubbles can be filled or emptied according to the controller. First bubbles are arranged in the backrest and the seat part of the motor vehicle seat in a two-column arrangement on either side of the spine contact region of the backrest, beneath the thigh contact region, or beneath the contact region of the hip bones. Second bubbles may be arranged in the side flanges region of the seat and/or backrest or in the lumbar support or head support regions. The controller outputs a haptic signal when a predefined event occurs to inform a vehicle occupant that as event has occurred, by the controller applying a predefined filling or emptying pattern to at least one of the first and/or second bubbles.

### CROSS REFERENCE TO RELATED APPLICATIONS

The application claims priority on and the benefit German Patent Application No. 10 2019 101 935.4 having a filing date of 25 Jan. 2019.

### BACKGROUND OF THE INVENTION

### Technical Field

The invention relates to a motor vehicle seat system and to a method for operating same.

### Prior Art

Known motor vehicle seat systems, as known for example from DE 102007015432 A1 and EP 3015335 A1, comprise a motor vehicle seat that comprises bubbles to be filled with fluid, often air. In these documents, these bubbles are used to generate a haptic indicator which signals to the driver or seat occupant that some sort of event has occurred which concerns the vehicle and requires their attention. Depending on the detected event, a bubble in the motor vehicle seat is then either inflated or emptied.

That said, the known systems can only haptically indicate a small number of different events. As motor vehicles become increasingly technologically advanced, however, the on-board electronics have a whole range of possibilities for detecting particular events. If there was a desire to represent such events via a haptic indication, there would have to be a differentiation between the various events (for example lane change, flat tire, open door) by means of different filling or emptying speeds or by means of different pulse patterns in the bubbles. However, given that some of the events in question may require immediate action, the vehicle occupant cannot be expected to have to differentiate between a whole range of different pulse patterns.

### BRIEF SUMMARY OF THE INVENTION

The problem addressed by the present invention is therefore that of providing a motor vehicle seat system and a method for operating same, by means of which it is not only possible to haptically indicate a relevant event, but also for the user to be able to intuitively detect a specific hazardous situation or the like.

This problem is solved by a motor vehicle seat system comprising a motor vehicle seat, in particular a driver's seat, wherein the motor vehicle seat comprises a plurality of bubbles that can be filled with fluid, as well as a controller and a line system which is connected to the bubbles and comprises lines leading to the bubbles, by means of which lines the bubbles can be filled or emptied according to the commands from the controller, wherein the bubbles comprise first bubbles which are arranged at least in the backrest and the seat part of the motor vehicle seat in a two-column arrangement on either side of the spine contact region of the backrest or in two columns beneath the thigh contact region or beneath the contact region of the hip bones, and/or comprise second bubbles which are arranged in the region of the side flanges of the seat part and/or backrest or in the region of the lumbar support or head support, wherein the controller is designed to output a corresponding haptic warning or information signal when a predefined event occurs in order to inform a vehicle occupant that a particular event has occurred, by the controller being designed to apply a predefined filling or emptying pattern to at least one of the first bubbles and/or second bubbles in order to thus haptically indicate the warning or information signal to the vehicle occupant.

This problem is solved by a method for operating a motor vehicle seat system, characterized in that the controller one or more bubbles in the case of the event:
“Door not closed” a bubble arranged in a side flange of the motor vehicle seat, in particular in a side flange facing the non-closed door, in particular in the seat part of said seat, is filled and emptied in a pulsed manner according to a predefined pattern;
“Hood open” at least one bubble arranged in the seat part of the motor vehicle seat, at the front in the travel direction, in particular in the foremost position, is filled and emptied in a pulsed manner according to a predefined pattern, with in particular the two foremost bubbles in the travel direction being filled and emptied alternately;
“Trunk open” at least one, preferably two, of the bubbles arranged in the seat part of the motor vehicle seat at the rear in the travel direction and at least one, preferably two, bubbles arranged in the backrest are filled and emptied alternately;
“Fuel reserve” at least one, preferably two, bubbles arranged in the seat part of the motor vehicle seat, in particular arranged centrally with respect to the travel direction, are filled and emptied in a pulsed manner, in particular rapidly, when a motor vehicle is started up and/or shut off;
“Occupant not wearing seat belt” at least one bubble arranged in the shoulder region of the backrest of the motor vehicle seat and/or at least one bubble arranged in the region of the belt buckle on the seat part of the motor vehicle seat are filled and emptied in a pulsed manner and/or a bubble arranged in the seat part, in particular at the rear in the travel direction, and/or a bubble arranged in the backrest of the motor vehicle seat is filled and emptied in a pulsed manner, the bubble filled in a pulsed manner being associated with the seat in a motor vehicle on which a person is sitting without wearing a seat belt;
“Vehicle fault” or “Driver distracted” a bubble arranged in the spine region of the backrest is filled and emptied in a pulsed manner, with in particular the bubble initially being pulsed at a low intensity, and later at a higher intensity, in the case of event “Driver distracted”;
“Service required” at least one bubble arranged in the backrest, in particular in the central and/or upper region of the backrest, is filled and emptied in a pulsed manner, in particular slowly, when a vehicle is started up and/or shut off;
“Handbrake activated” at least one bubble arranged in the seat part so as to face the center of the vehicle and/or a bubble arranged in the backrest so as to face the center of the vehicle is filled and emptied in a pulsed manner;
“Low external temperature” at least two bubbles or horizontal rows of bubbles arranged one above the other in the vertical direction are filled and emptied alternately;
“Flat tire” of the four bubbles arranged in the seat part, the one associated with a tire for which a drop in pressure has been determined is filled and emptied in a pulsed manner;
“Lane change” depending on the direction of the lane change, bubbles arranged in the right-hand or left-hand side flanges of the backrest and the seat part or bubbles arranged in the right-hand or left-hand column in the backrest and the seat part are filled, in particular in a pronounced manner;
“Cross traffic” the bubbles arranged in the backrest column located on the hazard side of the cross traffic are filled, in particular in a pronounced manner,
“Insufficient distance” at least one bubble arranged in the seat part, in particular the foremost bubble in the travel direction, is filled, and subsequently bubbles arranged in the side flanges are filled, in particular in a pronounced manner;
“Exit from the vehicle” at least one bubble arranged in the side flange of the motor vehicle seat facing the open door of a motor vehicle is filled, in particular in a pronounced manner;
“Left turn” bubbles arranged in the foremost horizontal row, in the travel direction, of the seat part and an additional bubble arranged on the left-hand side of the seat part when viewed in the travel direction are filled;
“Vehicle collision” at least one bubble arranged in the seat part, in particular the foremost bubble in the travel direction, is filled and, simultaneously, bubbles arranged in the side flanges are filled, in particular in a pronounced manner;
“Destination reached” bubbles arranged along at least one column in the backrest are filled from the bottom to the top;
“Road block ahead” bubbles arranged in the upper region of the backrest are filled alternately in columns;
“Traffic jam ahead” bubbles arranged along at least one column in the backrest are filled from the top to the bottom;
“Driver decision required” bubbles arranged in the lower region of the backrest are filled alternately in columns;
“Light fault” at least one, preferably two, of the bubbles arranged in the backrest of the motor vehicle seat are filled and emptied, in particular slowly, in a pulsed manner when a motor vehicle is started up and/or shut off; and
“Pedestrian” a single bubble arranged in the seat part, in particular in the foremost horizontal row in the travel direction, is filled, in particular in a pronounced manner.

Advantageous embodiments can be found in the dependent claims.

The subject matter according to the invention involves a motor vehicle seat system comprising a motor vehicle seat, in particular a driver's seat, wherein the motor vehicle seat comprises a plurality of bubbles that can be filled with fluid, as well as a controller and a line system which is connected to the bubbles and comprises lines leading to the bubbles, by means of which lines the bubbles can be filled or emptied according to the commands from the controller. The bubbles comprise first bubbles which are arranged at least in the backrest and the seat part of the motor vehicle seat in a two-column arrangement on either side of the spine contact region of the backrest or in two columns beneath the thigh contact region or beneath the contact region of the hip bones, and/or comprise second bubbles which are arranged in the region of the side flanges of the seat part and/or backrest or in the region of the lumbar support or head support. A large number of bubbles in the backrest, in the seat part, in the head support and/or in the contact region of the thigh makes it possible for there to be a significant variation of haptic signals, which allows for many different types of information. According to the invention, the controller is designed to output a corresponding haptic warning or information signal when a predefined event occurs in order to inform a vehicle occupant that a particular event has occurred, by the controller being designed to apply a predefined filling or emptying pattern to at least one of the first bubbles and/or second bubbles in order to thus haptically indicate the warning or information signal to the vehicle occupant. It is possible not only to output signals to different locations on the body, but also to increase the number of different signal patterns by configuring the signal shape and/or strength.

In order to generate a whole range of different haptic indicators, it is sufficient for example for the backrest and/or the seat part to comprise a matrix consisting of at least two columns having bubbles arranged one below the other in the vertical direction in the backrest and bubbles arranged one behind the other in the travel direction in the seat part. This makes it possible to haptically indicate events which the driver then associates with “front/rear,” “up/down,” “right/left” when bubbles are accordingly provided with a signal at the front, rear (e.g. in the seat part), top, bottom (e.g. in the backrest) or to the right or left.

The present invention therefore makes it possible to have a “spatially resolved” haptic indicator for a whole range of events which can intuitively draw the driver's attention in the “right direction.”

In a preferred embodiment, the motor vehicle seat has a massage system and/or seat adjustment system which comprises a plurality of bubbles which can be filled with fluid and are in the form of massage bubbles and/or seat adjustment bubbles. If a motor vehicle seat has a massage system, the infrastructure of bubbles, supply lines and the controller can be used to transmit the warning and/or information signals to the vehicle occupant by means of or via the system. It is particularly advantageous when the first bubbles are massage bubbles. As with the massage system, it may be particularly advantageous to use an existing seat adjustment system for this application, with the two bubbles being seat adjustment bubbles. It is very particularly advantageous for both systems to be present and used.

Usually, bubbles of massage systems and/or seat adjustment systems do not cover the entire body surface with which an occupant touches the surfaces of a motor vehicle seat. In a particularly preferred embodiment, at least one additional bubble is arranged in the spine contact region, which additional bubble is neither a massage nor a seat adjustment bubble and is also connected to a line system, and the controller or a control device independent thereof can apply a predefined filling or emptying pattern to the additional bubble when a predefined event occurs in order to thus haptically indicate the warning or information signal to the vehicle occupant. For instance, the bubble pressing directly against the spine or part of the spine can signal warnings particularly effectively. This is perceived by the occupant at said location in particular in a way that is particularly disturbing or unpleasant, such that the response of such bubbles in the region of the spine draws the occupant's attention thereto relative quickly. Consequently, the bubble at the spine is particularly suitable for warnings that are appropriate for serious hazardous situations.

In a further particularly preferred embodiment, the motor vehicle seat system comprises at least one pressure accumulator which is connected to the line system or can be switched to the line system by the controller, so that it can accelerate the process of filling the bubbles when the predefined event occurs. A pressure accumulator makes it possible to fill bubbles more quickly. The response time of the system is reduced, as a result of which the signals can be transmitted more quickly. Only faster filling of a bubble can provide the occupant with an additional attention signal and thus enhance the perception of the information and/or warning signal.

In principle, the bubbles can be filled and emptied in a pulsed manner at a constant or variable frequency. It is also possible for the bubble to be significantly inflated for a specific period of time in order to signal an event, and thus not to be pulsed.

In a very particularly preferred embodiment, the particular event comprises at least one of the following events:
a. “Door not closed”
b. “Hood open”
c. “Trunk open”
d. “Fuel reserve”
e. “Occupant not wearing seat belt”
f. “Vehicle fault”
g. “Service required”
h. “Driver distracted”
i. “Handbrake activated”
j. “Low external temperature”
k. “Flat tire”
l. “Lane change”
m. “Cross traffic”
n. “Insufficient distance”
o. “Exit from the vehicle”
p. “Left turn”
q. “Vehicle collision”
r. “Destination reached”
s. “Road block ahead”
t. “Traffic jam ahead”
u. “Driver decision required”
v. “Light fault”
w. “Pedestrian.”

Other events are conceivable which concern the driver, the occupant, the operational capability of the motor vehicle and/or a wide range of traffic situations.

The problem is also solved by a method for operating a motor vehicle seat system according to the very particularly preferred embodiment, wherein the controller is designed to one or more bubbles in the case of the event, with the events a. through w. listed below corresponding to the events a. through w. listed above:
a. a bubble arranged in a side flange of the motor vehicle seat, in particular in a side flange facing the non-closed door, in particular in the seat part of said seat, is filled and emptied in a pulsed manner according to a predefined pattern;
b. at least one bubble arranged in the seat part of the motor vehicle seat, at the front in the travel direction (X), in particular in the foremost position, is filled and emptied in a pulsed manner according to a predefined pattern, with in particular the two foremost bubbles in the travel direction (X) being filled and emptied alternately;
c. at least one, preferably two, of the bubbles arranged in the seat part of the motor vehicle seat at the rear in the travel direction (X) and at least one, preferably two, bubbles arranged in the backrest are filled and emptied alternately;
d. at least one, preferably two, bubbles arranged in the seat part of the motor vehicle seat, in particular arranged centrally with respect to the travel direction (X), are filled and emptied in a pulsed manner, in particular rapidly, when a motor vehicle is started up and/or shut off;
e. at least one bubble arranged in the shoulder region of the backrest of the motor vehicle seat and/or at least one bubble arranged in the region of the belt buckle on the seat part of the motor vehicle seat are filled and emptied in a pulsed manner and/or a bubble arranged in the seat part, in particular at the rear in the travel direction (X), and/or a bubble arranged in the backrest of the motor vehicle seat is filled and emptied in a pulsed manner, the bubble filled in a pulsed manner being associated with the seat in a motor vehicle on which a person is sitting without wearing a seat belt;
f. or h. a bubble arranged in the spine region of the backrest is filled and emptied in a pulsed manner, with in particular the bubble initially being pulsed at a low intensity, and later at a higher intensity, in the case of event h.;
g. at least one bubble arranged in the backrest, in particular in the central and/or upper region of the backrest, is filled and emptied in a pulsed manner, in particular slowly, when a vehicle is started up and/or shut off;
i. at least one bubble arranged in the seat part so as to face the center of the vehicle and/or a bubble arranged in the backrest so as to face the center of the vehicle is filled and emptied in a pulsed manner;
j. at least two bubbles or horizontal rows of bubbles arranged one above the other in the vertical direction (Z) are filled and emptied alternately;
k. of the four bubbles arranged in the seat part, the one associated with a tire for which a drop in pressure has been determined is filled and emptied in a pulsed manner;
l. depending on the direction of the lane change, bubbles arranged in the right-hand or left-hand side flanges of the backrest and the seat part or bubbles arranged in the right-hand or left-hand column in the backrest and the seat part are filled, in particular in a pronounced manner;
m. the bubbles arranged in the backrest column located on the hazard side of the cross traffic are filled, in particular in a pronounced manner,
n. at least one bubble arranged in the seat part, in particular the foremost bubble in the travel direction (X), is filled, and subsequently bubbles arranged in the side flanges are filled, in particular in a pronounced manner;
o. at least one bubble arranged in the side flange of the motor vehicle seat facing the open door of a motor vehicle is filled, in particular in a pronounced manner;
p. bubbles arranged in the foremost horizontal row, in the travel direction (X), of the seat part and an additional bubble arranged on the left-hand side of the seat part when viewed in the travel direction (X) are filled;
q. at least one bubble arranged in the seat part, in particular the foremost bubble in the travel direction (X), is filled and, simultaneously, bubbles arranged in the side flanges are filled, in particular in a pronounced manner;
r. bubbles arranged along at least one column in the backrest are filled from the bottom to the top;
s. bubbles arranged in the upper region of the backrest are filled alternately in columns;
t. bubbles arranged along at least one column in the backrest are filled from the top to the bottom;
u. bubbles arranged in the lower region of the backrest are filled alternately in columns;
v. at least one, preferably two, of the bubbles arranged in the backrest of the motor vehicle seat are filled and emptied, in particular slowly, in a pulsed manner when a motor vehicle is started up and/or shut off; and
w. a single bubble arranged in the seat part, in particular in the foremost horizontal row in the travel direction (X), is filled, in particular in a pronounced manner.

The above list is of course only a non-exhaustive list of signals which happen in response to the occurrence of particular events in and/or around the vehicle and can haptically warn and/or inform the occupant.

Using a motor vehicle seat system according to the invention, an occupant, in particular the driver, of a vehicle can be haptically informed of a large number of events in and around the motor vehicle. It has been found to be advantageous for these haptic warning and/or information signals to be linked with other warning and/or information indicators, e.g. of a visual or acoustic nature. For instance, an indicator signal can also show the driver which information and/or warning is present. It is also possible to output an acoustic warning signal in order to assist the process of drawing attention to the occurred event.

### BRIEF DESCRIPTION OF THE DRAWINGS

The invention will be explained in more detail in the following with reference to the drawings and embodiments. In the drawings:

FIG. 1 shows an embodiment of a motor vehicle seat system comprising a large number of bubbles; and,

FIGS. 2 to 24 show various types of signals which can be transmitted to the occupant.

### DETAILED DESCRIPTION OF PREFERRED EMBODIMENTS

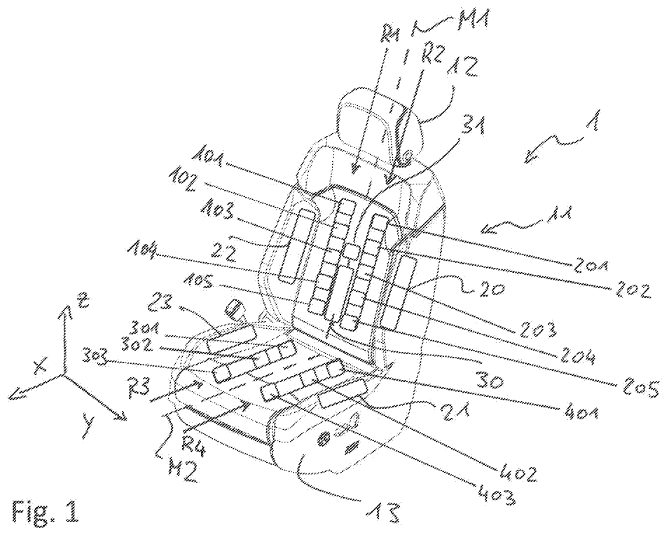

FIG. 1 shows an exemplary motor vehicle seat system comprising a motor vehicle seat 1 that includes a seat part 13, a backrest 11 and a head support 12. In this embodiment, a large number of bubbles 20-23, 30, 31, 101-105, 201-205, 301-303, 401-403 are arranged in the backrest 11 and the seat part 13. The arrangement is one possibility of how the bubbles may be arranged and simply shows where individual bubbles may be positioned. In this case, there are first bubbles 101-105, 201-205, 301-303, 401-403 which are optionally associated with a massage system, and second bubbles 20-23 which are optionally associated with a seat adjustment system, and further bubbles 30, 31 without an additional function.

In this case, bubbles 101-105, 201-205 (in the embodiment shown this is therefore in five rows, but there may also be two, three, four or more than five) are arranged in the backrest 11 to the left and right of the spine region M1 in two columns R1, R2 and can also be used for back massages in addition to the information and/or warning function. Adjusting bubbles 20, 22 by means of which information and/or warning signals can also be transmitted are arranged in the laterally arranged flanges. Two bubbles 30, 31 are arranged in the spine region M1 which are not associated with a function other than the information and/or warning function.

The side flanges of the seat part 13 are fitted with adjusting bubbles 21, 23 in order e.g. to reduce the seat width between the flanges where necessary or to adjust the lateral support. The bubbles 21, 23 can also be used to transmit information and/or warning signals to the outer thighs of an occupant. Two columns R3, R4 of bubbles 301-303, 401-403 (in the embodiment shown this is therefore in three rows, but there may also be two or more than three) are arranged to the left and right of the center of the thigh contact region M2, i.e. where the thighs rest on the seat part, and can be used to massage the thighs and to transmit information and/or warning signals from below to the thighs. It is not shown that the bubbles 20-23, 30, 31, 101-105, 201-205, 301-303, 401-403 are each connected to a line system via a valve, via which system they can be filled, or the relevant valve can also be opened to empty the bubbles. Additional elements of the bubble infrastructure such as a pressurized container, pumps, a controller and switches are not shown either.

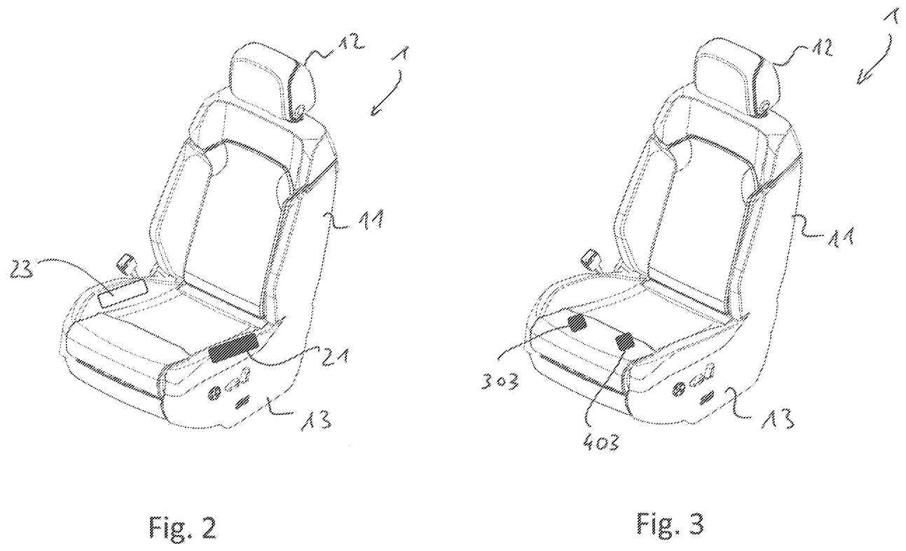

FIGS. 2 to 24 show examples of specific bubble combinations by means of which information and/or warning signals can be generated. The embodiment of the motor vehicle seat 1 according to the invention which is described by way of example in FIG. 1 has been selected for all of the examples.

FIG. 2 shows how the two bubbles 21, 23 arranged in the side flanges of the seat part 13 can be used for the “door not closed” signal. The bubble 21 is filled and emptied in a pulsed manner according to a predefined pattern on the side on which the door is not closed, in this case on the left-hand side.

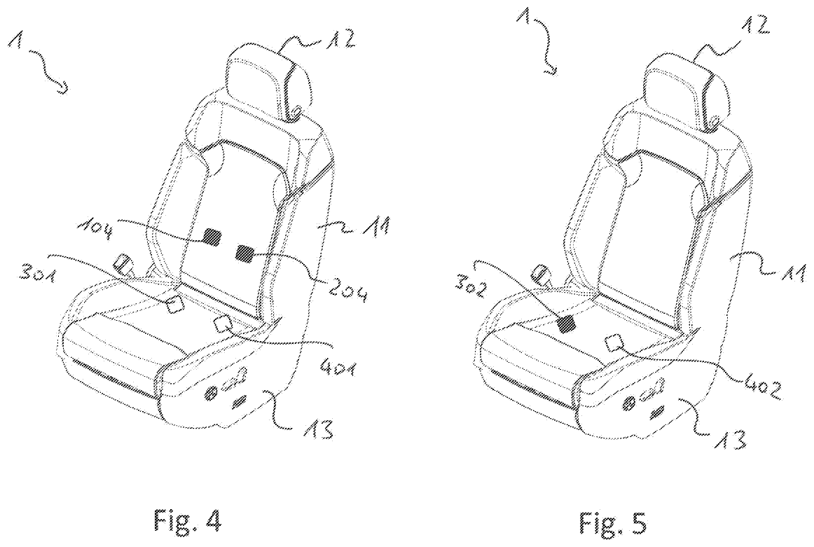

In FIG. 3 the two bubbles 303, 403 arranged in the foremost position in the seat part 13 are filled and emptied in a pulsed manner according to a predefined pattern, which is intended to signal to the occupant that the hood is open. In this row, the signal example shown in FIG. 4, in which the bubbles 301, 401 at the rear on the seat part 13 and at least one, preferably both bubbles 104, 204 arranged in the backrest 11 are filled and emptied alternately, can indicate that the trunk is open.

By means of the signal shown in FIG. 5, in which two bubbles 302, 402 arranged in the seat part 13, in particular centrally with respect to the travel direction X, are filled and emptied in a pulsed manner, in particular rapidly, when the motor vehicle is started up and shut off, the driver's attention can be drawn to decreasing fuel reserves.

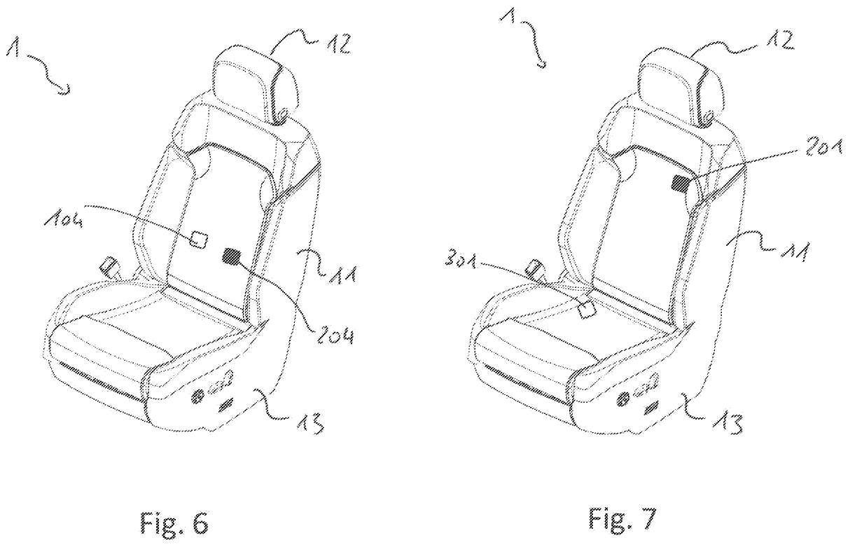

The example shown in FIG. 6, in which at least one, preferably two bubbles 104, 204 arranged in the backrest 11 are filled and emptied in a pulsed manner, in particular slowly, when the motor vehicle is started up and shut off, can indicate to the occupant that a lighting means is faulty.

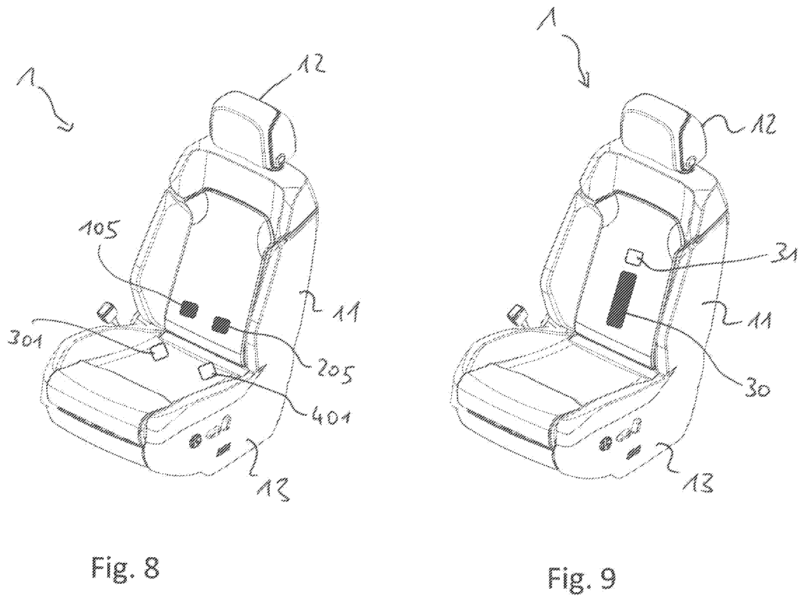

If, as shown in FIG. 7, the bubble 201 arranged in the shoulder region of the backrest 11 of the motor vehicle seat 1, which bubble faces the suspension point of the seat belt, and/or at least one bubble 301 arranged in the region of the belt buckle on the seat part 13 is filled and emptied in a pulsed manner, this can indicate to the occupant that a seat belt is not fastened. This warning signal can also be given, as shown in FIG. 8, by a bubble 301, 401 arranged in the seat part, in particular at the rear in the travel direction X, and/or a bubble 105, 205 arranged in the backrest 11 being filled and emptied, with the bubble 105, 205, 301, 401 filled in a pulsed manner being associated with the seat in a motor vehicle on which a person is sitting who is not wearing a seat belt. This signal can be transmitted to the driver's seat, which then prompts the occupant not wearing a seat belt to wear it.

FIG. 9 shows how a bubble 30, 31 arranged in the spine region M1 of the backrest 11 is filled and emptied in a pulsed manner. This unusual position directly on the spine is intended to inform the driver of a serious event. For instance, this signal can be used to draw the driver's attention to a fault on the vehicle; however, this signal may also be used to make the driver aware of his own failure to pay attention due to fatigue or the like. In this respect, the pulsing could begin at a low intensity, and the intensity could then continuously increase if no remedial action is taken.

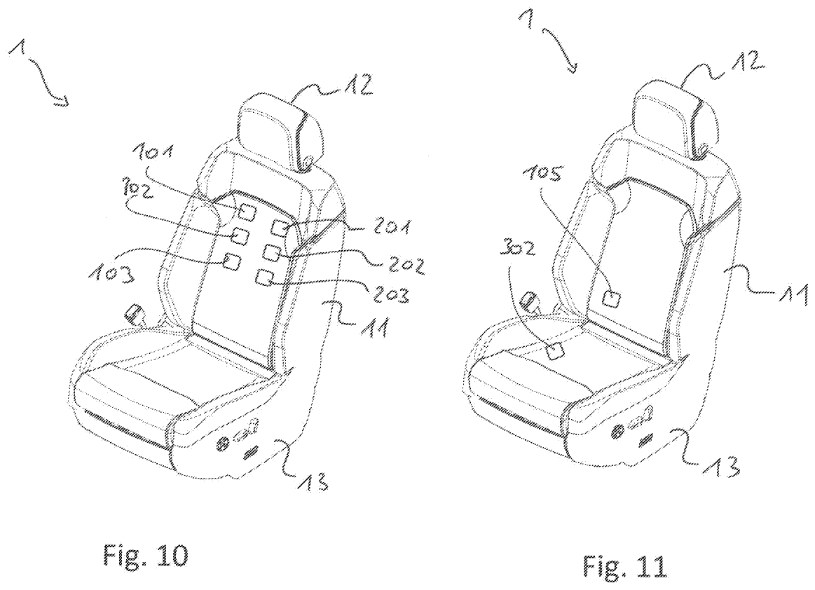

The bubbles 101-103, 201-203 shown in FIG. 10 in the central and/or upper region of the backrest 11 can be slowly emptied and filled in a pulsed manner when the vehicle is started up and/or shut off if for example a service is required.

If at least one bubble arranged in the seat part 13 so as to face the center of the vehicle, with the bubble 302 being highlighted in FIG. 11, and/or one bubble arranged in the backrest 11 so as to face the center of the vehicle, such as the bubble 105 shown in FIG. 11, is filled and emptied in a pulsed manner, this signal indicates that a handbrake has been activated.

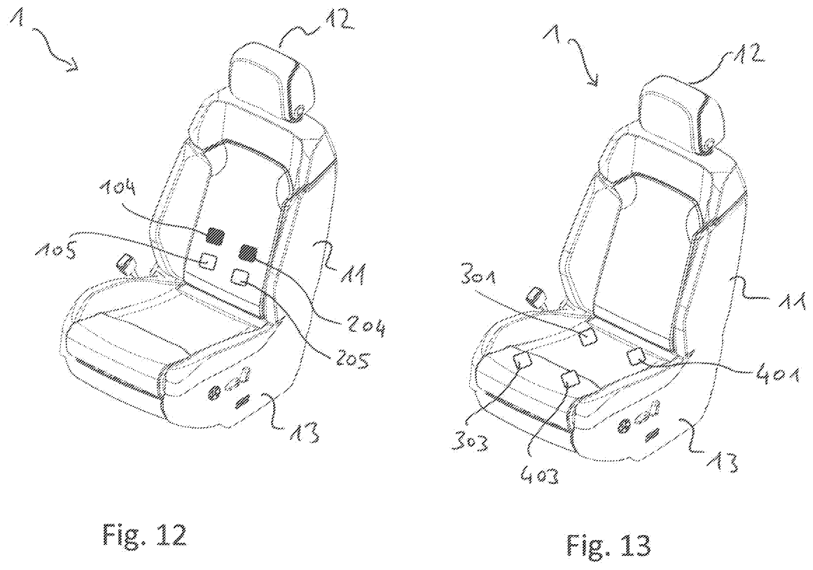

If, as shown in FIG. 12, at least two bubbles 104, 105, 204, 205 arranged one above the other in the vertical direction Z are filled and emptied alternately, this indicates a low external temperature.

The four bubbles 301, 303, 401, 403 arranged in the seat part 13, as shown in FIG. 13, can indicate a drop in pressure in one of the tires, with the position of the bubble 301, 303, 401, 403 on the seat surface correlating with the corresponding position of the tire on the motor vehicle.

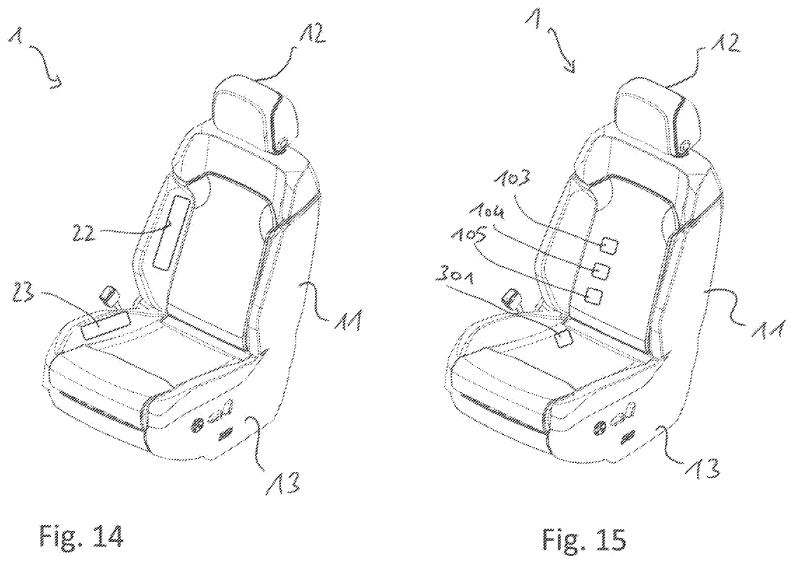

In the case of a planned lane change, the bubbles 20-23 positioned in the side flanges of the seat part 13 and the backrest 11 in the direction of the lane change indicate, by means of pulsed filling and emptying, whether the lane to which the vehicle is supposed to change to is free. In FIG. 14, which shows a lane change to the right, this is the bubbles 22, 23; and in FIG. 19, which shows a lane change to the left, this is the bubbles 20, 21. If another vehicle is located immediately next to the vehicle, the bubble 23 (FIG. 14) or the bubble 21 (FIG. 19) reacts; if a vehicle is located in the corresponding blind spot behind said vehicle, the bubble 22 (FIG. 14) or bubble 21 (FIG. 19) reacts. Alternatively, the signal can also be transmitted, as shown in FIG. 15, by the rear bubble (in this case: 301) on the corresponding side of the seat surface together with the lower bubbles 103-105 in the corresponding column of the backrest 11. It is appropriate in this case for a particularly strong signal to be transmitted so that the driver reacts immediately and an accident is avoided.

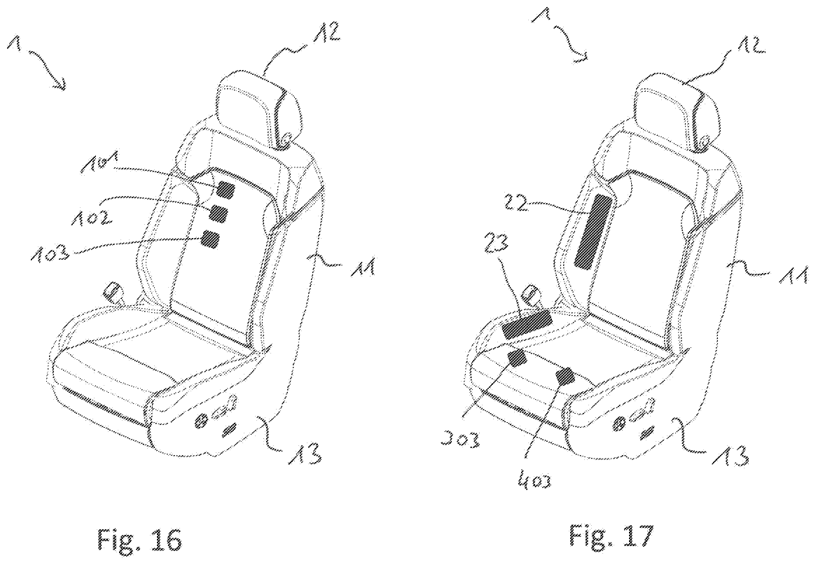

FIG. 16 shows pronounced filling of the upper bubbles 101-103 in the right-hand column R1 of the backrest 11, which indicates cross traffic from the right. The bubbles 201-203 would be filled if the cross traffic came from the left.

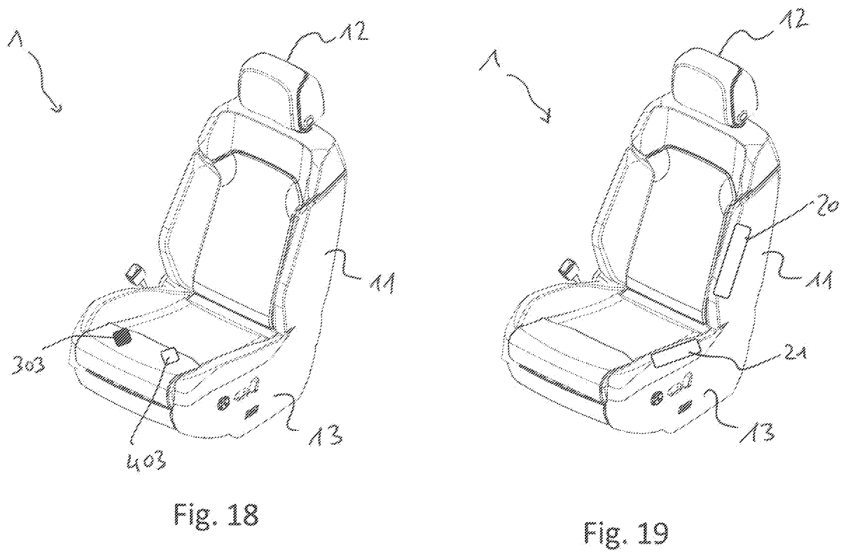

If the distance between the vehicle and vehicle in front is insufficient, bubbles 303, 403 arranged right at the front in the seat part 13 are filled and emptied again alternately, as shown in FIG. 18. If there is a risk of the vehicle being involved in a collision, the two bubbles 303, 403 pulse synchronously, with the bubbles 20-23 arranged in the side flanges, as shown in FIG. 17, being filled in a pronounced manner.

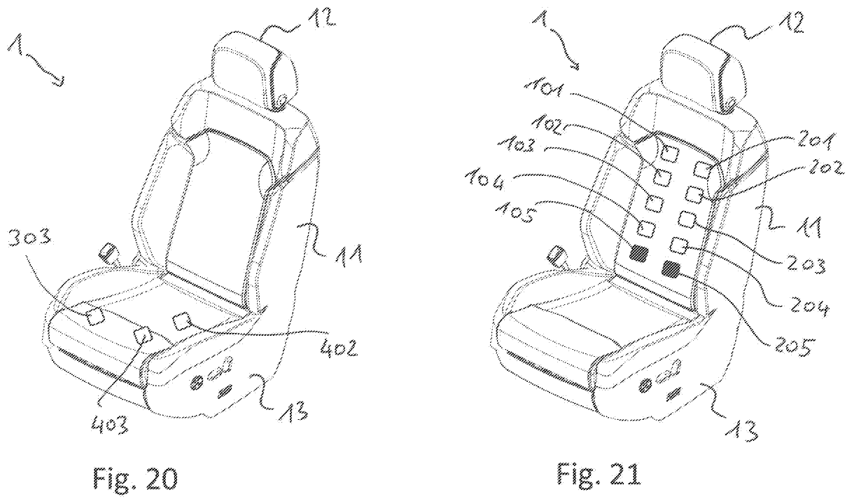

If a navigation device is used, the directions can also be supported by haptic signals. For instance, a left turn, as shown in FIG. 20, can be indicated such that the two front bubbles 303, 403 of the seat part 13 and a further bubble 402 arranged on the left-hand side of the seat part when viewed in the travel direction X are filled. For a right turn, the bubble 302 on the right-hand side can be filled in addition to the two front bubbles 303, 403.

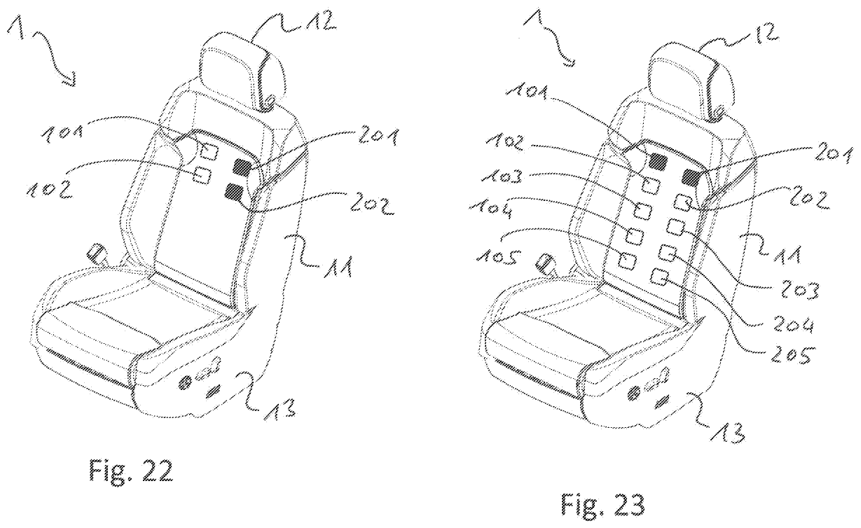

When the destination is reached, the bubbles 101-105, 201-205 arranged in the backrest 11 along at least one column R1, R2, as shown in FIG. 21, are filled from the bottom to the top. If the navigation system identifies a road block on the route, the bubbles 101, 102, 201, 202 arranged in the upper region of the backrest 11, as shown in FIG. 22, are filled alternately in columns. If there is a traffic jam ahead, the bubbles arranged in the backrest along at least one column R1, R2, as shown in FIG. 23, are filled from the top to the bottom.

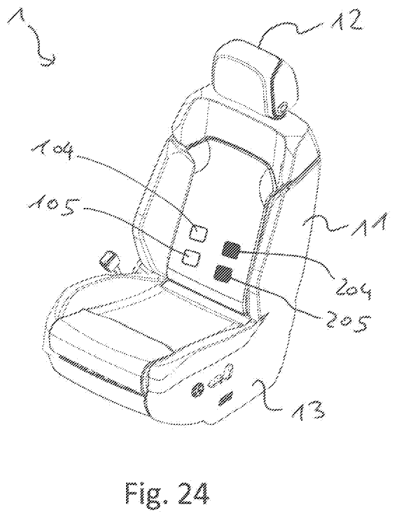

In the case of autonomous driving, the system may require a decision from the driver. For instance, the signal shown in FIG. 24 that bubbles 104, 105, 204, 205 arranged in the lower region of the backrest 11 are filled and emptied alternately in columns can thus be used to prompt the occupant, in particular the driver, to make a driving decision.

1. A motor vehicle seat system comprising a motor vehicle seat (1), in particular a driver's seat, wherein the motor vehicle seat (1) comprises
a plurality of bubbles (101-105, 201-205, 301-303, 401-403; 20-23) that can be filled with fluid,
a controller, and
a line system which is connected to the bubbles (101-105, 201-205, 301-305, 401-405; 20-23) and comprises lines leading to the bubbles (101-105, 201-205, 301-305, 401-405; 20-23), by means of which lines the bubbles (101-105, 201-205, 301-303, 401-403; 20-23) can be filled or emptied according to the commands from the controller,
wherein the bubbles (101-105, 201-205, 301-303, 401-403; 20-23) comprise first bubbles (101-105, 201-205, 301-303, 401-403) which are arranged at least in the backrest (11) and the seat part (13) of the motor vehicle seat in a two-column arrangement (R1, R2) on either side of the spine contact region (M1) of the backrest or in two columns (R3, R4) beneath the thigh contact region or beneath the contact region of the hip bones, and/or comprise second bubbles (20-23) which are arranged in the region of the side flanges of the seat part and/or backrest or in the region of the lumbar support or head support (12),
wherein the controller is designed to output a corresponding haptic warning or information signal when a predefined event occurs in order to inform a vehicle occupant that a particular event has occurred, by the controller being designed to apply a predefined filling or emptying pattern to at least one of the first bubbles (101-105, 201-205, 301-303, 401-403) and/or second bubbles (20-23) in order to thus haptically indicate the warning or information signal to the vehicle occupant.

2. The motor vehicle seat system according to claim 1, wherein the motor vehicle seat (1) further comprises a massage system and/or seat adjustment system which comprises a plurality of bubbles (101-105, 201-205, 301-303, 401-403; 20-23) which can be filled with fluid and are in the form of massage bubbles (101-105, 201-205, 301-303, 401-403) and or seat adjustment bubbles (20-23).

3. The motor vehicle seat system according to claim 2, wherein the first bubbles are massage bubbles.

4. The motor vehicle seat system according to claim 2, wherein the second bubbles are seat adjustment bubbles.

5. The motor vehicle seat system according to claim 1, further comprising at least one additional bubble (30, 31) arranged in the spine contact region (M1), which additional bubble is neither a massage nor a seat adjustment bubble and is also connected to a line system, and the controller or a control device independent thereof can apply a predefined filling or emptying pattern to the additional bubble (30, 31) when a predefined event occurs in order to thus haptically indicate the warning or information signal to the vehicle occupant.

6. The motor vehicle seat system according to claim 1, further comprising at least one pressure accumulator which is connected to the line system or can be switched to the line system by the controller, so that it can accelerate the process of filling the bubbles (101-105, 201-205, 301-303, 401-403; 20-23; 30, 31) when the predefined event occurs.

7. A motor vehicle seat system according to claim 6, wherein the particular event comprises at least one of the following events:
“Door not closed”;
“Hood open”;
“Trunk open”;
“Fuel reserve”;
“Occupant not wearing seat belt”;
“Vehicle fault”;
“Service required”;
“Driver distracted”;
“Handbrake activated”;
“Low external temperature”;
“Flat tire”;
“Lane change”;
“Cross traffic”;
“Insufficient distance”;
“Exit from the vehicle”;
“Left turn”;
“Vehicle collision”;
“Destination reached”;
“Road block ahead”;
“Traffic jam ahead”;
“Driver decision required”;
“Light fault”; and
“Pedestrian”.

8. A method for operating a motor vehicle seat system according to claim 7, wherein the controller causes the filling or emptying of one or more of the bubbles (101-105, 201-205, 301-303, 401-403; 20-23; 30, 31) in the case of the event:
“Door not closed” a bubble (21) arranged in a side flange of the motor vehicle seat (1), in particular in a side flange facing the non-closed door, in particular in the seat part (13) of said seat, is filled and emptied in a pulsed manner according to a predefined pattern;
“Hood open” at least one bubble (303, 403) arranged in the seat part (13) of the motor vehicle seat (1), at the front in the travel direction (X), in particular in the foremost position, is filled and emptied in a pulsed manner according to a predefined pattern, with in particular the two foremost bubbles (303, 403) in the travel direction (X) being filled and emptied alternately;
“Trunk open” at least one, preferably two, of the bubbles (301, 401) arranged in the seat part (13) of the motor vehicle seat (1) at the rear in the travel direction (X) and at least one, preferably two, bubbles (104, 204) arranged in the backrest (11) are filled and emptied alternately;
“Fuel reserve” at least one, preferably two, bubbles (302, 402) arranged in the seat part (13) of the motor vehicle seat (1), in particular arranged centrally with respect to the travel direction (X), are filled and emptied in a pulsed manner, in particular rapidly, when a motor vehicle is started up and/or shut off;
“Occupant not wearing seat belt” at least one bubble (201) arranged in the shoulder region of the backrest of the motor vehicle seat (1) and/or at least one bubble (301) arranged in the region of the belt buckle on the seat part (13) of the motor vehicle seat (1) are filled and emptied in a pulsed manner and/or a bubble (301, 401) arranged in the seat part (13), in particular at the rear in the travel direction (X), and/or a bubble (105, 205) arranged in the backrest (11) of the motor vehicle seat (1) is filled and emptied in a pulsed manner, the bubble (105, 205, 301, 401) filled in a pulsed manner being associated with the seat in a motor vehicle on which a person is sitting without wearing a seat belt;
“Vehicle fault” or “Driver distracted” a bubble (30, 31) arranged in the spine region (M1) of the backrest (11) is filled and emptied in a pulsed manner, with in particular the bubble (30, 31) initially being pulsed at a low intensity, and later at a higher intensity, in the case of event;
“Service required” at least one bubble (101-103; 201-203) arranged in the backrest (11), in particular in the central and/or upper region of the backrest (11), is filled and emptied in a pulsed manner, in particular slowly, when a vehicle is started up and/or shut off;
“Handbrake activated” at least one bubble (303) arranged in the seat part (13) so as to face the center of the vehicle and/or a bubble (105) arranged in the backrest (11) so as to face the center of the vehicle is filled and emptied in a pulsed manner;
“Low external temperature” at least two bubbles (105, 104; 205, 204) or horizontal rows of bubbles arranged one above the other in the vertical direction (Z) are filled and emptied alternately;
“Flat tire” of the four bubbles (301, 303, 401, 403) arranged in the seat part (13), the one associated with a tire for which a drop in pressure has been determined is filled and emptied in a pulsed manner;
“Lane change” depending on the direction of the lane change, bubbles (20, 21; 22, 23) arranged in the right-hand or left-hand side flanges of the backrest (11) and the seat part (13) or bubbles (301, 401, 103-105; 203-205) arranged in the right-hand or left-hand column in the backrest (11) and the seat part (13) are filled, in particular in a pronounced manner;
“Cross traffic” the bubbles (101-103) arranged in the backrest (11) column located on the hazard side of the cross traffic are filled, in particular in a pronounced manner,
“Insufficient distance” at least one bubble (303, 403) arranged in the seat part (13), in particular the foremost bubble in the travel direction (X), is filled, and subsequently bubbles arranged in the side flanges are filled, in particular in a pronounced manner;
“Exit from the vehicle” at least one bubble (20, 21; 22; 23) arranged in the side flange of the motor vehicle seat (1) facing the open door of a motor vehicle is filled, in particular in a pronounced manner;
“Left turn” bubbles (303, 403) arranged in the foremost horizontal row, in the travel direction (X), of the seat part (13) and an additional bubble (402) arranged on the left-hand side of the seat part (13) when viewed in the travel direction (X) are filled;
“Vehicle collision” at least one bubble (303, 403) arranged in the seat part (13), in particular the foremost bubble in the travel direction (X), is filled and, simultaneously, bubbles arranged in the side flanges are filled, in particular in a pronounced manner;
“Destination reached” bubbles (101-105; 201-205) arranged along at least one column (R1, R2) in the backrest (11) are filled from the bottom to the top;
“Road block ahead” bubbles (101, 102; 201, 202) arranged in the upper region of the backrest (11) are filled alternately in columns;
“Traffic jam ahead” bubbles (101-105; 201-205) arranged along at least one column (R1, R2) in the backrest (11) are filled from the top to the bottom;
“Driver decision required” bubbles (104, 105; 204, 205) arranged in the lower region of the backrest (11) are filled alternately in columns;
“Light fault” at least one, preferably two, of the bubbles (104, 204) arranged in the backrest (11) of the motor vehicle seat (1) are filled and emptied, in particular slowly, in a pulsed manner when a motor vehicle is started up and/or shut off; and
“Pedestrian” a single bubble (303) arranged in the seat part (13), in particular in the foremost horizontal row in the travel direction (X), is filled, in particular in a pronounced manner.
